(19) United States
(12) Patent Application Publication
(10) Pub. No.: US 2015/0019182 A1
(43) Pub. Date: Jan. 15, 2015

(54) OBTAINING PARAMETERS OF A TRANSPORT SYSTEM

(71) Applicant: KONE Corporation, Helsinki (FI)

(72) Inventors: Tapio TYNI, Hyvinkaa (FI); Pekka PERÄLÄ, Kerava (FI)

(21) Appl. No.: 14/335,608

(22) Filed: Jul. 18, 2014

Related U.S. Application Data
(63) Continuation of application No. PCT/EP2013/052006, filed on Feb. 1, 2013.

(30) Foreign Application Priority Data
Feb. 1, 2012 (FI) 20125105

(51) Int. Cl. G06F 17/50; G06F 17/10

(52) U.S. Cl. CPC G06F 17/5045; G06F 17/10
USPC 703/2; 703/7

(57) ABSTRACT

The invention refers to a method for obtaining the system parameters of a transport system, particularly an elevator, in which method
a) at least first and second input parameters of the transport system are determined,
b) a power model fitting to the transport is provided, which power model comprises motor model components and hoistway model components,
c) model parameters describing power flow in the transport system are fitted into the power model,
d) the model parameters are optimized under use of at least one of the input parameters of the elevator,
e) the optimized model parameters are post processed to obtain at least one of the system parameters of the transport system. The system provides missing system information about a transport system, particularly in cases in which an existing system is to be renovated with a new motor.

### BACKGROUND OF THE INVENTION

1. Field of the Invention

The present invention relates to a method for obtaining or adapting the parameters of a transport system, particularly an elevator. The adaptation of parameters is implemented using a power model of the transport system.

2. Description of Background Art

In elevator modernization projects it is essential to know the system masses when engineering a new motor-drive system in the cases where existing hoist way mechanics is reused. Car acceleration together with the hoisting motor power will reveal the secrets of the elevator system parameters when state of the art sensor, measurement, modeling and optimization techniques are applied. The developed KONE ESiteSurvey™ method provides a comprehensive set of elevator system parameters readily after a round trip test run and out-of-service time less than 30 minutes. The parameters include e.g. masses, frictions, balancing, compensation, hoist motor and hoist way efficiencies. The method is now part of the KONE standard modernization process in the high-rise segment.

The number of old tall buildings which need major elevator modernization is growing globally more than 5% per annum, in some markets even 15% per annum. New buildings appear around the old buildings and it is a challenge to keep the old buildings competitive to attract tenants. Typical reasons to make a major modernization to the building's People Flow™ systems is usually poor reliability due to the main components wear and tear and/or poor traffic handling performance due to old controls systems and probably a change of the building usage or increased population.

For a major modernization there are three main different approaches: (1) keep the old motor and hoisting system, (2) keep the hoisting system but change the motor and (3) make a full replacement.

The full replacement is obviously the most expensive one and disturbs for long time the building operations. On the other hand, if the old hoisting system and the DC motor are kept, it will provide less disturbance but the energy efficiency and the long term reliability are sacrificed. Reused DC motors involve reliability risks, like insulation damage due to the higher excitation stress of present drive technologies, broken bearings or even motor shaft breakdowns have been seen.

Since the DC-motor technology in general is also in the end of its life cycle, the most optimum alternative for the major modernization is to keep the old guiderails and hoisting system but replace the existing motor with the highly efficient and reliable

Permanent Magnet Synchronous Motor technology. This approach is environmentally sustainable as it provides the least amount of waste and the most energy efficient and reliable long term solution.

The challenge in replacing the motor while keeping the most of the old system is to get to know the main key parameters of the existing system to enable to engineer a safe and reliable new solution. Most critical parameters are the masses of the existing key components and the hoisting system balancing. Occasionally weight information can be found from the plates attached to the components, but experience has shown that this information is unreliable due to the possible non-documented changes made to the system over the years.

Until today, the masses of the main components have had to be surveyed with lot of on site effort. The efforts include sometimes even dismantling the system to subcomponents and weighing them separately to get accurate enough information. This always means long out of service times—even weeks. This paper describes an innovative procedure for accurately finding out the key parameters accurately from which ever traction elevator with minimum disturbance to the elevator availability, with only about 30 minutes out of service time, thus enabling to engineer safe and reliable solution.

Commonly in the elevator industry, in order to gather understanding of the elevator system, the outputs, like acceleration or speed, of the system are recorded and analyzed, eg (Ebeling 2011), (Lorsbach 2010). This approach will provide some viewpoint to the system operation, condition and behaviour. However, when the system is controlled with a feedback loop, the monitored output behaviour can remain unaffected although there were significant abnormalities in the system parameters, like for example in balancing of the car/counterweight system or in hoistway friction.

In order to obtain a more comprehensive view about the objective system the input excitation and output response signals together with system model identification and estimation techniques are required (Ljung 1999), (The MathWorks 2011). The traditional way to form a system model for a mechanical system is based on force balances acting on the system, eg (Lehtinen et al. 1998). This has the drawback that it requires essential a priori information about the objective system. In this application the motor current-to-torque characteristics should be known beforehand. Generally and particularly in modernization projects it is not possible to obtain this information about an arbitrary old elevator system being modernized.

Instead of the ordinary force model, a power or energy balance model approach has been adopted here. The fundamental principle of energy preservation omits the need of any beforehand knowledge of the investigated system. In fact, it is possible to compute many characteristics of the system while post-processing the energy model outputs, including the mentioned current-to-torque operating curve of the motor.

Prior art document FI119764B1 relates to an arrangement and a method for the adaptation of parameters in a transport system. The arrangement comprises a power model, wherein power flow in the transport system is described by means of transport system parameters, which include input parameters and status parameters.

### SUMMARY OF THE INVENTION

In a method according to the invention for obtaining the parameters of a transport system,

a) at least first and second input parameters of the transport system are determined, e.g. measured during one or several test runs.

b) A power model fitting to the transport is provided, which power model comprises motor model components and hoistway model components,

c) model parameters describing power flow in the transport system are fitted into the power model,

d) the model parameters are optimized under use of at least one of the input parameters of the elevator, and

e) the optimized model parameters are post processed to obtain at least one of the system parameters of the transport system.

Thus, the model parameters may be optimized in step d) on the basis of at least the first input parameter, measured in step a). This input parameter is advantageously the Power fed to the electric motor Pₘₑ.

Preferably at least one status parameter of the transport system, e.g. the friction of the hoistway system or the mass of the car or counterweight is obtained using the optimized parameters of the power model and the second input parameter, which is for example the acceleration a of the elevator car. In the method at least one additional system parameter describing the transport system is solved by post-processing the optimized parameters of the power model. This additional parameter may e.g. be the mass of the car or counterweight. In this connection the post processing may include e.g. the definition of an inertia model, whereby the post-processing of the optimized parameters from the power model via the inertia model solves car mass m_{car} and/or counterweight mass m_{cwt}.

The optimization of the model parameters in step d) is preferably performed by comparison with the measured input parameters, which input parameters are measured during one or more test runs in step a). The model parameters are challenged as to minimize the difference between at least one of the input parameters and the corresponding model parameter.

The optimization can thus also be performed in a per se known manner by a genetic algorithm, which is able to develop with minimum effort under use of cross breeding an mutation increasingly optimized model parameters from generation to generation. The genetic algorithm can be stopped, if a preset allowed difference to the input parameter(s) has been underrun by the model parameter(s) of the last generation.

The invention concerns also a computing system comprising a transport system model section for simulating (e.g. estimating) a transport system operating process and outputting a simulation result, a simulation error minimizing section for correcting the simulation result by adjusting one or more of the transport system model parameters and a post processing section for further processing the adjusted transport system model parameter and operable to output one or more physical characteristics of a specified transport system component. Said transport system may be, for example, an elevator system or a conveyor system, such as a travelator system or an escalator system.

Said transport system may also be an automatic door drive system. Said physical characteristics may include elevator car mass, elevator counterweight mass, transport system motor efficiency and/or elevator hoistway efficiency. Said transport system model section is preferably a transport system power model section for simulating power flow in the transport system during transport system operation.

### BRIEF DESCRIPTION OF THE DRAWINGS

FIG. 1 illustrates how KONE Electric Site Survey or KONE ESiteSurvey™ exploits the power balance approach;

FIG. 2 is a graph of a test shaft, measured and calculated motor power vs. time;

FIG. 3 is a graph of a modernization project, measured and calculated motor power vs. time;

FIG. 4 are a graphs of the modernization project, hoisting system power components;

FIG. 5 are graphs of the modernization project, motor and hoistway efficiencies over Round Trip; and

FIG. 6 illustrates the data capturing hardware that can be used for both AC and DC motor systems.

### DETAILED DESCRIPTION OF THE PREFERRED EMBODIMENTS

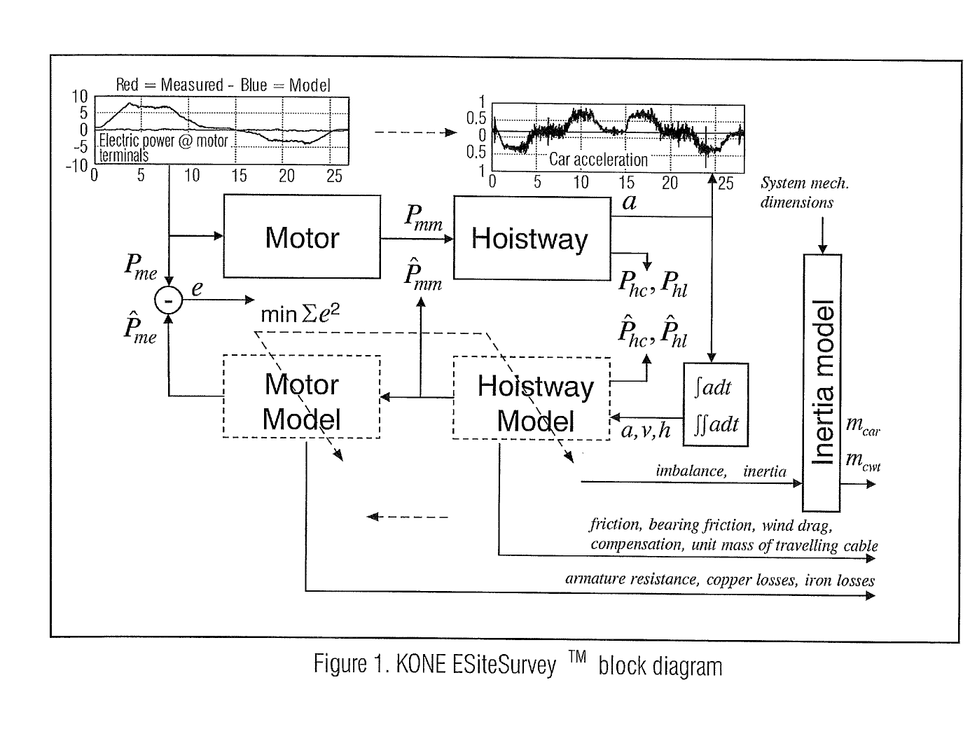

FIG. 1 illustrates how KONE Electric Site Survey or KONE ESiteSurvey™ exploits the power balance approach.

Motor electrical power Pₘₑ and car acceleration a are recorded as first and second input parameters of the transport system during a test round trip run from top to bottom floor and back. The motor has its internal losses, like copper losses due to the current through the armature and field windings. The mechanical power Pₘₘ obtainable at the motor traction wheel is the electrical power Pₘₑ minus the motor internal losses. The mechanical power Pₘₘ at the motor's traction wheel in turn acts as an excitation signal to the hoistway system. The Pₘₘ transforms in the hoistway partially into changes in useful conservative potential and kinetic energies P_{hc} and partially it is lost in friction type losses Pₕₗ. The consequence and indication of all these energy transformations along the power transmission chain is the car acceleration a. It is obvious that from real elevator system it is not possible to directly measure by any reasonable means neither the traction sheave instantaneous mechanical power nor the powers inside the hoistway.

In order to dig into the motor-hoistway system a power model based on power terms is formed, which power model is fitted to the transport system in question. Hereinafter the description only refers to an elevator as transport system. Anyway this does not exclude other transport systems, e.g. escalators from the invention. Model parameters are hereinafter provided with roofed characters. The information flow in the model is reverse—the motor electrical power Pₘₑ is estimated based on the car state vector (a, v, h)^{T}. Further, the estimation error e is minimized over the set of motor power and car acceleration samples K collected during the round trip test run

$$e ( P ) = {\sum }_{k ∈ K} {( {\hat{P}}_{me} ( {a}_{k} , {v}_{k} , {h}_{k} , P ) - {P}_{mek} )}^{2} = min . \qquad ( 1 )$$

In the optimization problem (1) processed in step d) the velocity v and position h of the car is obtained by integrating the measured acceleration a. The vector P represents all the parameters for partial power terms included for the motor and hoistway models. For example the models for potential and kinetic power terms P_{P} and P_{K} in the hoistway model are

\hat{P}_{P}(a, v, h, m_{B}(h))=m_{B}(h)·g·v

\hat{P}_{K}(a, v, h, m_{I}(h))=m_{I}(h)·a·v,

\hat{P}_{hc}=\hat{P}_{P}+\hat{P}_{K} (2)

where m_{B} is the mass difference between car-counterweight system and other shaft components affecting to it, m_{I} is the equivalent total inertia mass of all moving or rotating components in the system, both are in kilograms and dependent of car location in the hoistway. Symbol g is the gravitational acceleration ˜9.81 m/s2.

Once the optimization problem (1) has been completed, the hoistway and motor parameters have been found and numerous additional parameters, figures of merits and performance indicators can be calculated. For example, based on the readily available estimates for the traction sheave power \hat{P}ₘₘ and hoistway conservative powers \hat{P}_{hc}, it is possible to calculate an estimation for the motor and hoistway efficiencies at any point k of the test run)

\hat{η}ₘ_{ₖ}=(\hat{P}ₘₘ_{ₖ} Pₘₑ_{ₖ}⁻¹)^{sign(P}^{ₘₑₖ}⁾ \hat{η}ₕ_{ₖ}=(\hat{P}_{hc}_{ₖ} \hat{P}ₘₘ_{ₖ}⁻¹)^{sign(P}^{_{hck}}⁾

|\hat{P}ₘₘ|>0|Pₘₑ|>0|\hat{P}_{hc}|>0 (3)

Equation (3) says that the real mechanical powers, impossible to measure on site, have been substituted with their estimates from the model. The efficiency figures from equation (3) are realistic in a way that they illustrate the real operating conditions and performance of the elevator. Typically eg the motor efficiencies are obtained in a torque test bench in a laboratory environment and are given at a certain nominal operating point.

For the high-rise modernization projects one of the most interesting and relevant questions are the car and counterweight masses m_{car} and m_{cwt}. As visible in the block diagram the basic system model does not divide the total equivalent linear inertia to mechanical system components. The model provides only the total linear inertia mass m_{I} and the system balancing mass m_{B}. In order to get hands on the car and counterweight masses, the inertia masses of the other moving components have to be known so that they can be counted out from the identified masses m_{I} and m_{B}.

Once the system power model has been properly formulated, the following relationship can be defined

$$\{ \begin{matrix}{m}_{B} = {m}_{car} - {m}_{cw t} \\ {m}_{I} = {m}_{car} + {m}_{c w t} + {m}_{IC}\end{matrix} , \qquad ( 4 )$$

where m_{IC} holds the linear inertia masses of all other moving components than car and counterweight. If a component c has rotational inertia, it has to be transferred first to its equivalent linear inertia with a transformation m_{Ic}=J_{c}/r_{c}², where J_{c} is the rotational inertia and r_{c} is the radius of the rotating element through which the component is connected to the system. If the roping ratio differs from 1:1 it has to be considered as well.

The following two examples illustrate the accuracy of the obtained results. The first case is from high rise test shaft, over 300 meters and the second is a modernization project.

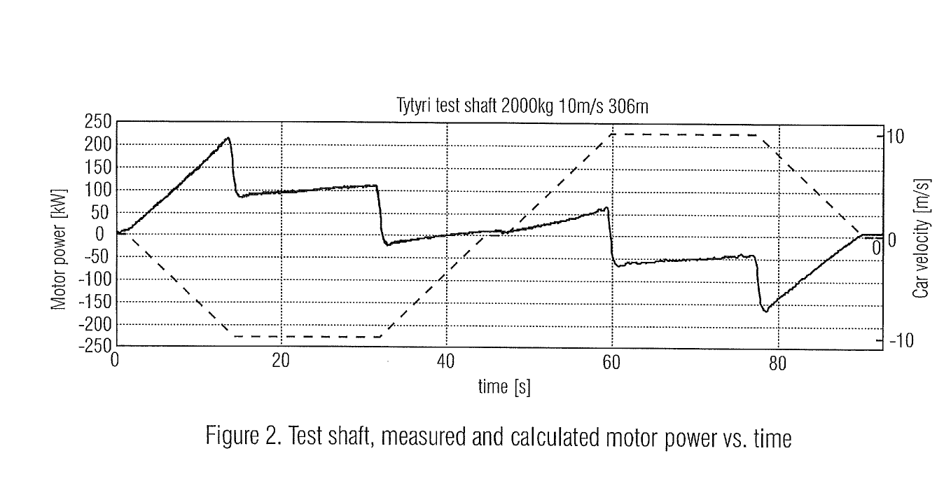

The test shaft was equipped with a KONE Permanent Magnet Synchronous Machinery MX100 and a 2000 kg capacity car reaching 10 m/s nominal speed. The data was gathered over the test round trip, see FIG. 2 below. The figure shows the measured motor power and the calculated power from the system model. As can be seen, the model fit is perfect; the mean error over the round trip is 1.2 kW as compared to the peak power 220 kW.

The system model gives m_{I}=16160 kg and m_{B}=−981 kg. The required sum of inertia masses m_{IC} in the equation (4) was collected from the component data sheets. Applying the equation (4) yields to m_{car}=3260 kg and m_{cwt}=4287 kg. The known component values were 3292 kg and 4273 kg, respectively. The differences are −32 kg and 14 kg. The masses given by the ESiteSurvey are very well inline with the known component masses.

During the nominal velocity regions the inclined power trend implies that the hoisting system might be overcompensated. The ESiteSurvey™ system model affirms this, as it reports +1.4 kg/m compensation error. The compensation error combines the effects of suspension/compensation ropes and travelling cable. Applying the car and counterweight masses and the nominal car capacity gives balancing percentages −49%, −38% and −27% at bottom, middle and top of the shaft. The minus sign means that the counterweight side is heavier than the car. Furthermore, the identified unit mass 3.3 kg/m of the travelling cables is exactly in line with the cable data sheets.

The test tower was an “easy” case, as it was possible to gather all the component inertia information from data sheets. In real modernization projects this is not the case, as the inertia data is normally not available.

Rope inertia masses are straightforward to define based on rope lengths and information from rope plates or diameter of the ropes. The pulleys are, and especially the motor is, more challenging. Fortunately the construction of the DC-motor normally such that the rotating parts can be split up into three main inertia components: armature, traction wheel, brake drum. Each of these three components can be modeled in the frame of an inertia model as a set of hollow cylinders with outer diameter D and inner diameter d having a rotational inertia

$$J ( D , d , l , ρ ) = \frac{l}{2} π [ {( \frac{D}{2} )}^{4} - {( \frac{d}{2} )}^{4} ] \cdot ρ , \qquad ( 5 )$$

where l is the length of the cylinder and ρ is the density of material. As inertia increases in power to 4 with the diameter, usually only the outer main brim is enough to consider. If more accuracy is needed then also the body structure can be modeled as a cylinder with d=0 and D=d_{brim}.

In the modernisation project the existing DC motors are replaced with permanent magnet synchronous motors whereas the car and counterweight are reused. Site survey was made during the tendering phase. The main goal was to find out the masses of the car and counterweight in order to ensure a safe, reliable and economical new hoisting solution. The inertias of the hoisting system components were defined as described above based on the measured dimensions and information from the rope plates. After receiving the modernization project one of the elevators was weighed in a traditional way to verify the results from the site survey

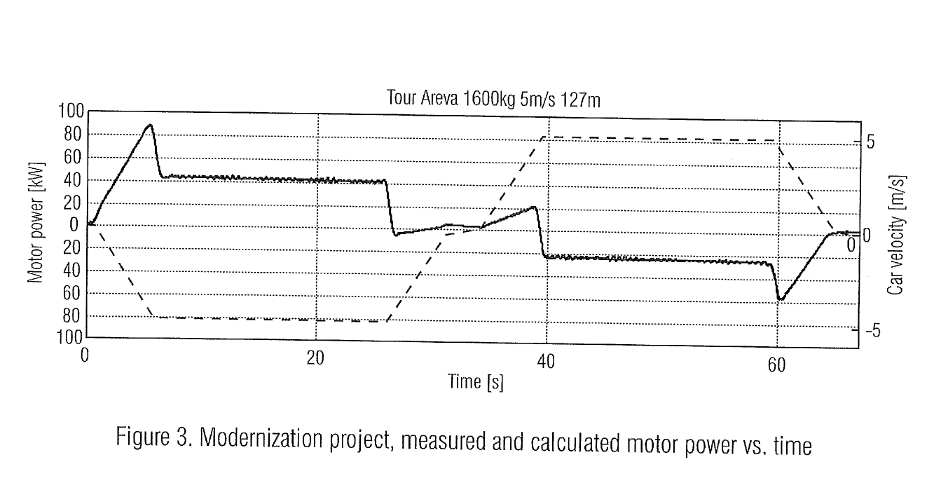

FIG. 3 shows the measured and estimated motor power from a unit with 1600 kg capacity, 5 m/s nominal speed, 1:1 roping and 127 m travel; average error is 0.5 kW over the round trip while the peak power is ˜90 kW. Part of the error comes from vibration type of noise caused by the vertical jerking of the car acceleration that the model does not even try to explain. The results of applying the inertia model are shown in the Table 1.

TABLE 1
Modernization project example, car and counterweight masses

| | ESiteSurvey [kg] | Weighed [kg] | Δ [kg] | Δ [%] |
|---|---|---|---|---|
| Car | 2783 | 2813 | −30 | −1.1 |
| Cwt | 3638 | 3675 | −37 | −1.0 |

Other interesting main parameters found from the hoisting system: slight under compensation −0.6 kg/m, travelling cable unit weight 2.7 kg/m and middle of the shaft balancing −850 kg/−53%.

The results of the example above show that it is possible to gather the component inertia information based on the dimensions and replace the laborious, tedious, obtrusive and lengthy traditional weighing procedure with the more convenient and less service disruptive method.

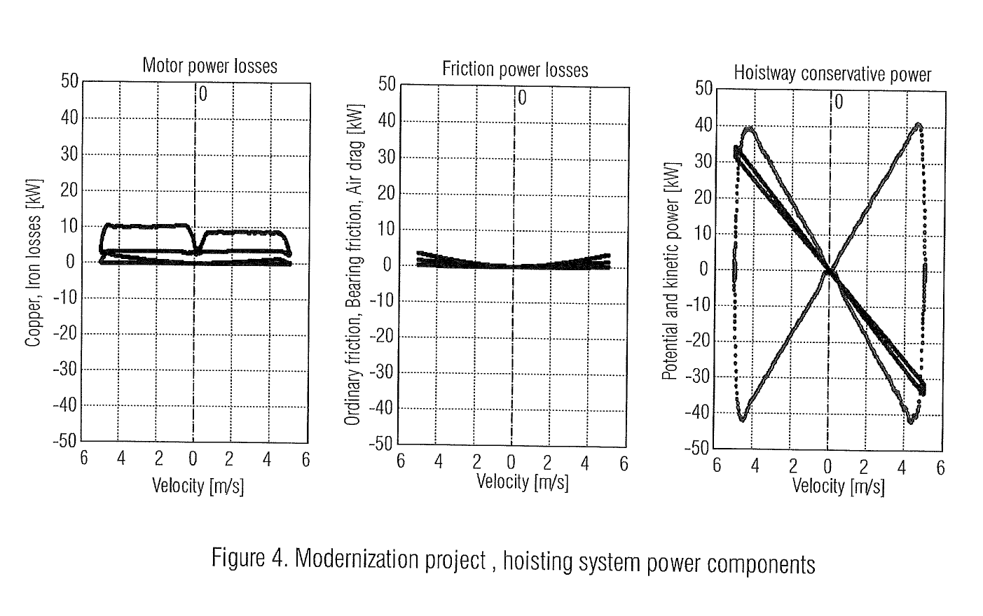

Once the model has been obtained it is possible also to study the behaviour and magnitudes of the power losses. FIG. 4 shows the 7 power components as a function of speed over the test round trip from the previous modernization project example. Graphs show clearly how losses always remain positive while the conservative kinetic and potential energies have negative values meaning they also release the energy they have taken. The graphs also show clearly the unpleasant property of an empty or full loaded car—the power levels required to accelerate and keep the masses moving are a way bigger than the powers wasted in the actual power losses.

It is possible to calculate where the motor energy is consumed by integrating the individual power terms over the test round trip, see Table 2.

TABLE 2
Modernization project example, energy components over round trip

| | Wh | % |
|---|---|---|
| Copper | 79.1 | 49.6 |
| Iron | 4.9 | 3.1 |
| Friction | 22.7 | 14.2 |
| Bearing | 49.4 | 31.0 |
| Wind | 3.3 | 2.1 |
| Total | 159.5 | 100 |

The top three hoisting system energy consumers from motor inputs are copper, bearing and friction losses. The magnitude of bearing losses is a bit surprising; from experience they are usually found to be smaller than friction losses. Therefore the bearings of the reused hoisting components need to be checked during the modernization process.

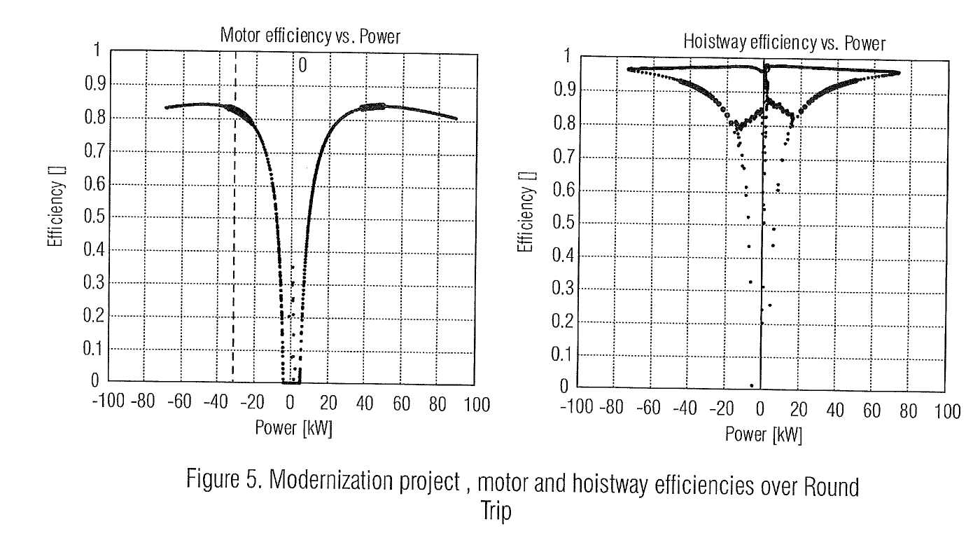

The efficiency of the motor and shaft in the modernization project example is shown in FIG. 5 as calculated according to equation (3). The instantaneous efficiency can be seen at every stage of the round trip. Consequently the efficiency could be called as “operating” or “dynamic” efficiency, as it shows the true operating performance of the system.

One interesting point to mention is the point when the system is accelerating to heavy direction and is just beginning to change from the acceleration state to the nominal speed state. This point is the highest positive peak power on the motor efficiency graph. The inferior efficiency at this point, when compared to constant speed efficiency, is due to the copper and iron losses in the motor. At this point the motor current has its maximum value while the armature commuting frequency is also close to the maximum frequency just before the nominal speed has been reached.

In addition to the instantaneous efficiencies also overall average efficiencies can be calculated over the round trip. In this case the motor round trip efficiency is 0.68, which is a typical low value for a DC-motor from this era. The overall shaft efficiency 0.91 instead is very good. It is necessary to bear in mind that the obtained efficiency figures always depend on the operating point of the system—the results here are for the empty car full travel round trip. Different loads and different trips will yield different efficiencies. Nevertheless, performing the test always in the same manner will provide comparable results from one system to another.

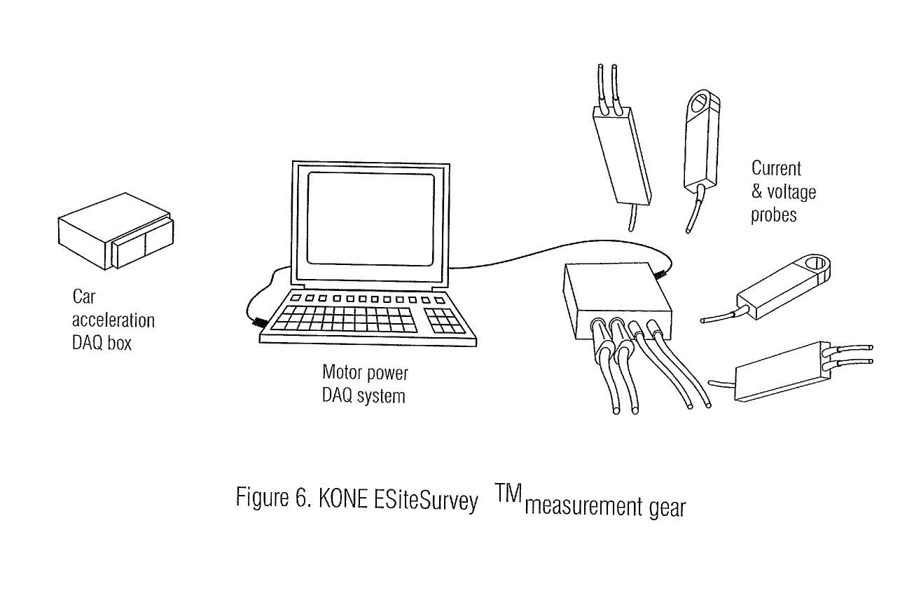

FIG. 6 shows the data capturing hardware that can be used for the both the AC and DC motor systems. There are two subsystems for logging the motor and car acceleration data.

For the motor power there is a small laptop-PC and an USB-based data acquisition box to measure the currents and voltages. DC-current clamps and isolated differential probes are required for safe measurements without distortion. For the car acceleration there is a stand-alone data acquisition box that rides on car floor during the test run and stores the data into a memory card. All the measuring equipment fit into a small carrying case weighing just a few kilograms. This can be compared to the real hardware needed for the traditional weighing of the system masses and to the traditional way to define the hoisting system balancing with a pile of heavy test weights.

The invention is not exclusively limited to the above-described embodiment examples, but many variations are possible within the scope of the inventive concept defined in the claims.

The invention can also be described by following items

1. Method for adapting the parameters of a transport system, in which method:
a power model is fitted into the arrangement, the power model comprising at least motor model and hoistway model,
parameters describing power flow in the transport system are fitted into the power model,
at least a first and a second transport system input parameter are determined,
the power model is updated on the basis of at least the first input parameter thus determined,
at least one transport system status parameter is adapted using at least the updated power model and the second input parameter
at least one additional parameter describing the transport system is solved by post-processing the power model outputs.

2. Method according to item 1, wherein the input parameters are car acceleration a and motor electric power Pₘₑ

3. Method according to item 1, wherein the additional parameter is at least one of car mass m_{car} and counterweight mass m_{cwt}
4. Method according to item 1, wherein an inertia model is defined; based on inertia model, post-processing solves at least one of car mass m_{car} and counterweight mass m_{cwt}

5. A computing system comprising:
a transport system model section for simulating a transport system operating process and outputting a simulation result
a simulation error minimizing section for correcting the simulation result by adjusting one or more of the transport system model parameters
a post processing section for further processing the adjusted transport system model parameter and operable to output one or more physical characteristics of a specified transport system component.

### REFERENCES

Ebeling T. (2011). Condition Monitoring for Elevators—An Overview. Lift-Report June 2011, pp. 25-26.

Lehtinen H., Hämäläinen J. J., Torenius P. and Tyni T. (1998) Simulation of elevator dynamics. 2nd Tampere International Conference on Machine Automation, ICMA'98, 15-18 Sep. 1998, Tampere, Finland.

Ljung L. (1999). System Identification: Theory for the User, 2nd edition, Prentice-Hall.

Lorsbach G. P. (2010). Analysis of Elevator Ride Quality and Vibration. Elevator World July 2010, pp. 154-162.

The Math Works Inc. (2011). Optimization Toolbox Users Guide, Revised for Version 6.1 (Release 2011b). http://www.mathworks.com/help/pdf_doc/optim/optim_tb.pdf

1. Method for obtaining the system parameters of a transport system, particularly an elevator, in which method
a) at least first and second input parameters of the transport system are determined,
b) a power model fitting to the transport is provided, which power model comprises motor model components and hoistway model components,
c) model parameters describing power flow in the transport system are fitted into the power model,
d) the model parameters are optimized under use of at least one of the input parameters of the elevator,
e) the optimized model parameters are post processed to obtain at least one of the system parameters of the transport system.

2. Method according to claim 1,
wherein the input parameters determined in step a) are the motor power Pₘₑ and the car acceleration a.

3. Method according to claim 1,
wherein the input parameters determined in step a) are the car mass m_{car} and the counterweight mass m_{cwt}.

4. Method according to claim 1,
wherein the model parameters are optimized by minimizing the error square of at least one of the first and second input parameters with respect to the corresponding model parameter.

5. Method according to claim 1,
wherein the power model comprises a motor model comprising the motor model components and a hoistway model comprising the hoistway model components.

6. Method according to claim 1, wherein the optimization in step d) is performed using the following formula:
$$e ( P ) = {\sum }_{k ∈ K} {( {\hat{P}}_{me} ( {a}_{k} , {v}_{k} , {h}_{k} , P ) - {P}_{mek} )}^{2} = min ,$$
wherein the velocity v and position h of the car is obtained by integrating the measured acceleration a and the vector P represents all the parameters for partial power terms included for the motor and hoistway models, whereby k is the number of acceleration samples.

7. Method according to claim 1,
wherein the motor model is
Pₘₑ=Pₘₘ+Pₐᵣ+P_{cl}+Pᵢₗ,
with Pₘₑ is the input energy to the motor, Pₘₘ is the power available at the traction wheel, Pₐᵣ are armature losses, P_{cl} are copper losses and Pᵢₗ are iron losses in the motor.

8. Method according to claim 1,
wherein the hoistway model is
Pₘₘ=P_{hc}+Pₕₗ=Pₚ+Pₖ+Pₕₗ,
wherein P_{hc} is the Energy of the moved hoistway components being the sum of the potential power Pₚ and the kinetic power Pₖ of the moved components in the hoistway, and Pₕₗ are the friction losses caused by the movement of components in the hoistway.

9. Method according to claim 1, wherein the potential power and the kinetic power in the model are determined as follows:
\hat{P}_{P}(a, v, h, m_{B}(h))=m_{B}(h)·g·v
\hat{P}_{K}(a, v, h, m_{I}(h))=m_{I}(h)·a·v,
\hat{P}_{hc}=\hat{P}_{P}+\hat{P}_{K}
wherein m_{B} is the mass difference between car-counterweight system and other shaft components affecting to it, m_{I} is the equivalent total inertia mass of all moving or rotating components in the system, both are in kilograms and dependent of car location in the hoistway, g is the gravitational acceleration.

10. Method according to claim 9, wherein the optimized parameters m_{B} and m_{I} are post processed by an inertia model represented by following equation to obtain the mass of the car and counterweight as system parameters
$$\{ \begin{matrix}{m}_{B} = {m}_{car} - {m}_{cw t} \\ {m}_{I} = {m}_{car} + {m}_{c w t} + {m}_{IC}\end{matrix} , \qquad$$
where m_{IC} represents the linear inertia masses of all other moving components than car and counterweight.

11. Method according to claim 10,
wherein in said inertia model any rotational inertia is transferred first to its equivalent linear inertia with a transformation m_{Ic}=J_{c}/r_{c}², where J_{c} is the rotational inertia and r_{c} is the radius of the rotating element through which the component is connected to the system.

12. Method according to claim 11, wherein rotational main inertia components, e.g. armature, traction sheave and/or brake drum are modeled as a hollow cylinder with an outer diameter D and an inner diameter d having a rotational inertia
$$J ( D , d , l , ρ ) = \frac{l}{2} π [ {( \frac{D}{2} )}^{4} - {( \frac{d}{2} )}^{4} ] \cdot ρ ,$$
where l is the length of the cylinder and ρ is the density of material.

13. Method according to claim 1 in that the optimized model parameters of the power available at the traction sheave Pₘₘ and the energy of the hoistway components P_{hc} are post processed by following formula to obtain hoistway and motor efficiencies at any point k of a test run performed in connection with step a)
\hat{η}ₘ_{ₖ}=(\hat{P}ₘₘ_{ₖ} Pₘₑ_{ₖ}⁻¹)^{sign(P}^{ₘₑₖ}⁾ \hat{η}ₕ_{ₖ}=(\hat{P}_{hc}_{ₖ} \hat{P}ₘₘ_{ₖ}⁻¹)^{sign(P}^{_{hck}}⁾
with |\hat{P}ₘₘ|>0|Pₘₑ|>0|\hat{P}_{hc}|>0.

14. Method according to claim 1, wherein the method is performed during the renovation of an existing elevator system wherein the old motor is replaced with a highly efficient and reliable Permanent Magnet Synchronous Motor technology.

15. Method according to claim 1, wherein the optimization in step d) is performed under use of a genetic algorithm.

16. A computing system comprising:
a transport system model section for simulating a transport system operating process and outputting a simulation result
a simulation error minimizing section for correcting the simulation result by adjusting one or more of the transport system model parameters
a post processing section for further processing the adjusted transport system model parameter and operable to output one or more physical characteristics of a specified transport system component.

17. Method according to claim 2,
wherein the input parameters determined in step a) are the car mass m_{car} and the counterweight mass m_{cwt}.

18. Method according to claim 2,
wherein the model parameters are optimized by minimizing the error square of at least one of the first and second input parameters with respect to the corresponding model parameter.

19. Method according to claim 3,
wherein the model parameters are optimized by minimizing the error square of at least one of the first and second input parameters with respect to the corresponding model parameter.

20. Method according to claim 2,
wherein the power model comprises a motor model comprising the motor model components and a hoistway model comprising the hoistway model components.
